(19) United States
(12) Patent Application Publication
(10) Pub. No.: US 2014/0132972 A1
(43) Pub. Date: May 15, 2014

(54) TERMINAL APPARATUS, IMAGE PROCESSING APPARATUS, AND IMAGE PROCESSING SYSTEM

(71) Applicant: Mie WATANABE, Tokyo (JP)

(72) Inventor: Mie WATANABE, Tokyo (JP)

(73) Assignee: RICOH COMPANY, LTD., Tokyo (JP)

(21) Appl. No.: 14/058,543

(22) Filed: Oct. 21, 2013

(30) Foreign Application Priority Data
Nov. 9, 2012 (JP) 2012-247809

(51) Int. Cl. H04N 1/00

(52) U.S. Cl. CPC H04N 1/00405
USPC 358/1.13

(57) ABSTRACT

In an image processing system that includes a terminal apparatus and multiple image processing apparatuses connected via a network, the image processing apparatus selectable after configuring intended print settings on the terminal apparatus. The configuration information is configured on the terminal apparatus to perform intended printing, and the configured configuration information is sent to the image processing apparatus. The image processing apparatus generates image information that indicates a result outputtable by the image processing apparatus based on the received configuration information and its own apparatus information. The terminal apparatus sends a command to print to the image processing apparatus selected by a user based on the sent multiple image information.

### CROSS-REFERENCE TO RELATED APPLICATION

This patent application is based on and claims priority pursuant to 35 U.S.C. §119 to Japanese Patent Application No. 2012-247809, filed on Nov. 9, 2012 in the Japan Patent Office, the entire disclosure of which is hereby incorporated by reference herein.

### BACKGROUND

1. Technical Field

The present invention relates to a terminal apparatus, image processing apparatus, and image processing system that includes the terminal apparatus and the image processing apparatus.

2. Background Art

Recently, an image processing system constructed by connecting multiple image processing apparatuses such as multi functional peripherals (MFPs) and terminal apparatuses via a network used by many people has become common. In this image processing system, supported print settings or configuration, such as print size and output range, might vary depending on the image processing apparatuses. In that case, a user needs to locate the image processing apparatus that can generate the intended print output with the desired print configuration.

However, in the conventional image processing system, the user sets the print configuration of the image processing apparatus after selecting an image processing apparatus as the output destination. Therefore, if the user finds that the selected image processing apparatus is not capable of providing the intended functions at the time of setting the print configuration, the user needs to select another image processing apparatus.

One solution is a print system in which a host controller ascertains the capabilities and performance of multiple printers connected to a network to select the most appropriate printer to print data without user involvement, identifies the most appropriate printer to the print data among multiple printers connected to the network, and sends the print data to the selected printer. However, the print system does not have the requisite flexibility since a user cannot select an alternative image processing apparatus freely.

### SUMMARY

One embodiment of the present invention provides a terminal apparatus that is configured to connect with a plurality of image processing apparatuses via a network and includes a configuration information setting unit that sets input configuration information, a configuration information transmitter that sends the configuration information set by the configuration information setting unit to the image processing apparatus, an image information receiver that receives image information outputtable by the image processing apparatus in response to the transmitted configuration information, and an image information display unit that displays an image generated based on the image information received by the image information receiver and the displayed image allows a user to select one of the plurality of image processing apparatuses. One embodiment of the present invention provides an image processing apparatus that includes a configuration information receiver that receives configuration information sent from the terminal apparatus, an apparatus information management unit that manages apparatus information that indicates output and post-processing executable by the image processing apparatus, an image information generator that generates image information outputtable by the image processing apparatus based on the received configuration information and the apparatus information, an image information transmitter that sends the image information generated by the image information generator to the terminal apparatus, and an image output unit that outputs an image based on the received configuration information in response to a command to output sent from the terminal apparatus. One embodiment of the present invention provides an information processing system including the above-described terminal apparatus and the image processing apparatus.

### BRIEF DESCRIPTION OF THE DRAWINGS

A more complete appreciation of the disclosure and many of the attendant advantages thereof will be readily obtained as the same becomes better understood by reference to the following detailed description when considered in conjunction with the accompanying drawings.

FIG. 1 is a schematic diagram illustrating an image processing system comprised of terminal apparatuses and image processing apparatuses as an embodiment of the present invention.

FIG. 2 is a block diagram illustrating part of the image processing apparatus as an embodiment of the present invention.

FIG. 3 is a block diagram illustrating part of the terminal apparatus as an embodiment of the present invention.

FIG. 4 is a diagram illustrating a process of sending and receiving information between the terminal apparatus and the image processing apparatus as an embodiment of the present invention.

FIGS. 5A and 5B are sequence diagrams illustrating a process of sending and receiving image information between the terminal apparatus and the multiple image processing apparatuses as an embodiment of the present invention.

FIG. 6 is a diagram illustrating images displayed on the terminal apparatus based on the image information as an embodiment of the present invention.

FIG. 7 is a diagram illustrating images based on the image information and unsupported settings based on difference information between configuration information and the image information as an embodiment of the present invention.

FIG. 8 is a sequence diagram illustrating the process shown in FIG. 7 to display unsupported settings based on difference information between configuration information and the image information as an embodiment of the present invention.

FIG. 9 is a diagram illustrating images based on the image information displayed on the terminal apparatus and extent of effect of post-processing on printed images as an embodiment of the present invention.

FIG. 10 is a sequence diagram illustrating the process shown in FIG. 9 to display image information and extent of effect of post-processing as an embodiment of the present invention.

FIG. 11 is a diagram illustrating image information and remaining amount of supplies displayed on the terminal apparatus as an embodiment of the present invention.

FIG. 12 is a sequence diagram illustrating the process shown in FIG. 11 to display image information and remaining amount of supplies on the terminal apparatus as an embodiment of the present invention.

FIG. 13 is an ordinal diagram illustrating images based on image information sent from the multiple image processing apparatuses displayed on the terminal apparatus as an embodiment of the present invention.

FIG. 14 is a sequence diagram illustrating the process shown in FIG. 13 to determine displaying order of image information on the terminal apparatus as an embodiment of the present invention.

FIG. 15 is a diagram illustrating a displaying process based on the image information in case process set by a user is unsupported and process nearest to print configuration set by the user is executed as an embodiment of the present invention.

FIG. 16 is a sequence diagram illustrating the process shown in FIG. 15 to request configuration and send and receive image information that includes a substitute process between the terminal apparatus and the image processing apparatus as an embodiment of the present invention.

FIG. 17 is a diagram illustrating displayed images and area information in case of specifying (or limiting) installation location of the image processing apparatus as an embodiment of the present invention.

FIG. 18 is a sequence diagram illustrating the process shown in FIG. 17 to specify the installation location of the image processing apparatus as an embodiment of the present invention.

### DETAILED DESCRIPTION

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In the following embodiment, an image processing system is provided, which includes a terminal apparatus and an image processing apparatus connected via a network and makes it possible for a user to select an image processing apparatus that performs outputting such as intended printouts as the user confirms a preview image (hereinafter referred to as image) outputtable by the image processing apparatus.

The image processing system enables selection of the image processing apparatus that performs outputting process based on the displayed image on the terminal apparatus.

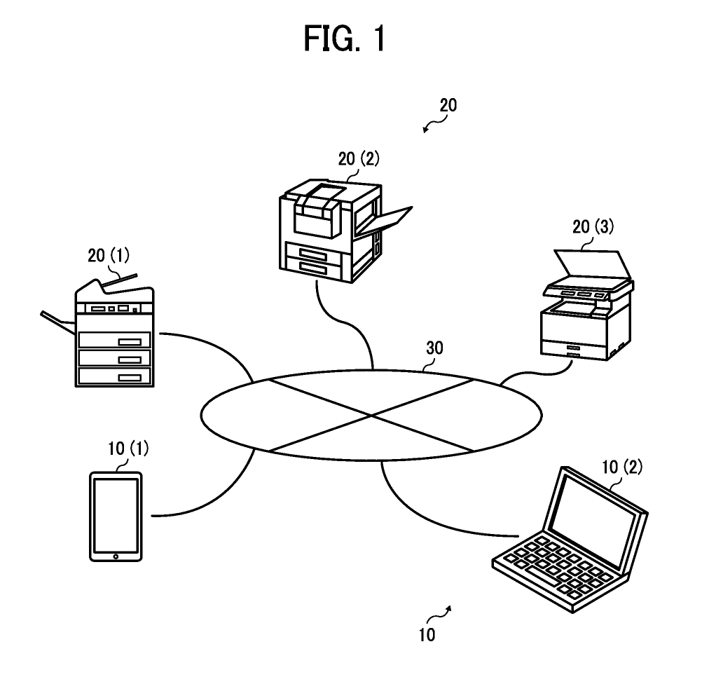

FIG. 1 is a schematic diagram illustrating an image processing system comprised of terminal apparatuses and image processing apparatuses in an embodiment of the present invention. In the image processing system shown in FIG. 1, multiple terminal apparatuses 10 such as a mobile terminal 10(1) and a personal computer (PC) 10(2) and multiple image processing apparatuses 20 such as multifunctional peripherals (MFPs) 20(1), 20(2), and 20(3) are connected to a same network 30 such as intranet and local area network (LAN).

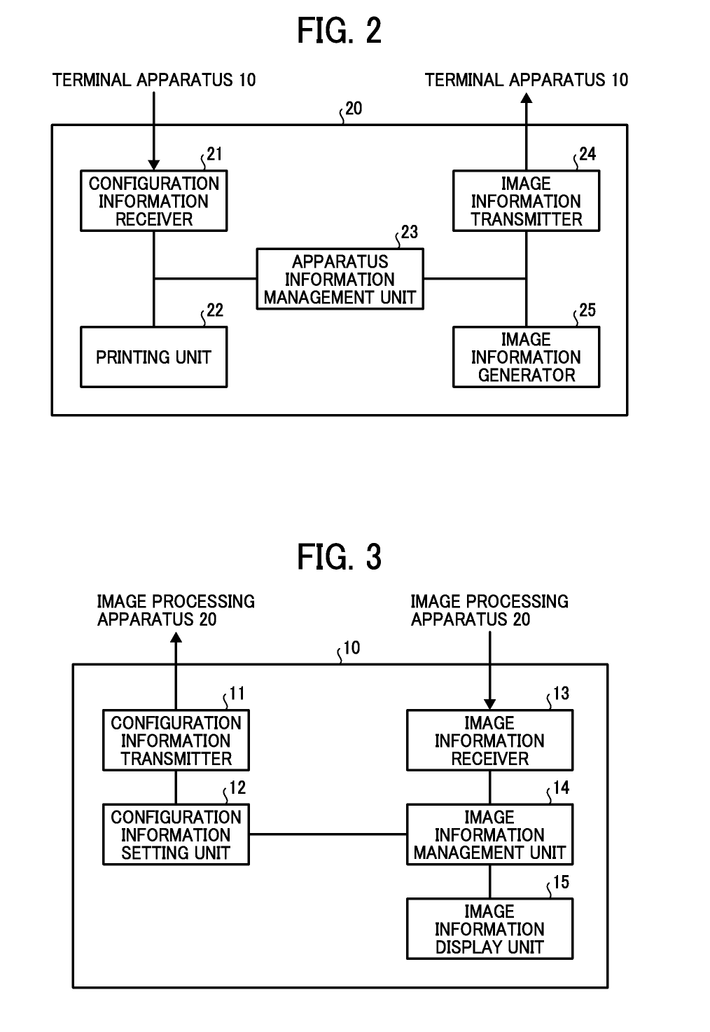

FIG. 2 is a block diagram illustrating part of the image processing apparatus 20. As shown in FIG. 2, the image processing apparatus 20 includes a configuration information receiver 21, a printing unit 22 as an output unit, an apparatus information management unit 23, an image information transmitter 24, and an image information generator 25. The configuration information receiver 21 receives configuration information sent from the terminal apparatus 10. The printing unit 22 performs a process to execute printing on a printer (not shown in figures) based on an output configuration (printing configuration) set by a user. In this embodiment, the printing unit 22 corresponds to an image output unit that outputs an image based on the received configuration information in response to a command to output sent from the terminal apparatus. The apparatus information management unit 23 stores, updates, analyzes, and identifies information on printing and post-processing executable by the image processing apparatus, information on supplies, and information on status of the image processing apparatus 20. In other words, the apparatus information management unit 23 manages the information described above. The image information generator 25 generates image information outputtable by the image processing apparatus 20 based on the received configuration information. The image information transmitter 24 sends the image information generated by the image information generator 25 to the terminal apparatus 10.

FIG. 3 is a block diagram illustrating part of the terminal apparatus 10. As shown in FIG. 3, the terminal apparatus 10 includes a configuration information setting unit 12, a configuration information transmitter 11, an image information receiver 13, an image information management unit 14, and an image information display unit 15. The configuration information setting unit 12 accepts configuration information of the image processing apparatus 20 input by a user and stores (registers) it. The configuration information transmitter 11 sends the configuration information set by the configuration information setting unit 12 to multiple image processing apparatuses 20. The image information receiver 13 receives image information sent from the multiple image processing apparatuses 20. After acquiring image information, etc., received by the image information receiver 13 from the image information management unit 14, the image information display unit 15 displays the image information, etc., on a display screen of a display device such as liquid crystal and electro-luminescence (EL).

The image information management unit 14 stores, updates, analyzes, and determines status information of the image processing apparatus 20 such as image information and supply information, etc., sent from the multiple image processing apparatus 20 and received by the image information receiver 13. In other words, the image information management unit 14 manages the information described above.

The functional units in the terminal apparatus 10 and the image processing apparatus 20 described above can be configured either as hardware or as functional units implemented by a computer executing program code.

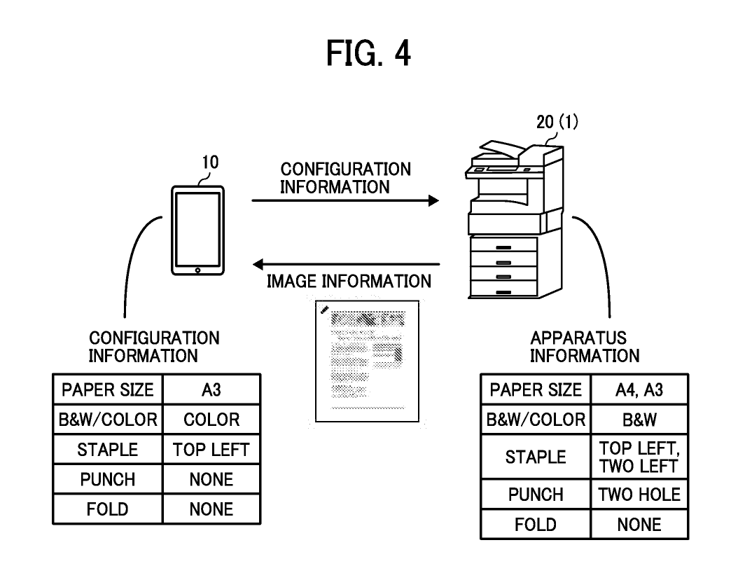

FIG. 4 is a diagram illustrating a process of sending and receiving information between the terminal apparatus 10 and the multiple image processing apparatuses 20. The user sends configuration information to the multiple image processing apparatuses 20(1), etc., and so on connected to the same network 30 by using the terminal apparatus 10. For example, the image processing apparatus 20(1) generates image information based on the received configuration information and apparatus information of the image processing apparatus 20(1) and sends the generated image information to the terminal apparatus 10. For example, the terminal apparatus 10 sends configuration information “paper size: A3, color, staple: top left, punch: none, fold: none” to the image processing apparatus 20. On the other hand, the image processing apparatus 20 holds apparatus information of its own e.g., “paper size: A4 and A3, b/w, staple: top left and two left, punch: two hole, fold: none”. In this case, the image processing apparatus 20(1) generates image information outputtable by the image processing apparatus 20(1) in accordance with the configuration information based on the received configuration information and the held apparatus information. That is, in this case, the image processing apparatus 20(1) generates image information regarding an output image “paper size: A3, b/w, staple: top left, punch: none, fold: none” and sends it to the terminal apparatus 10.

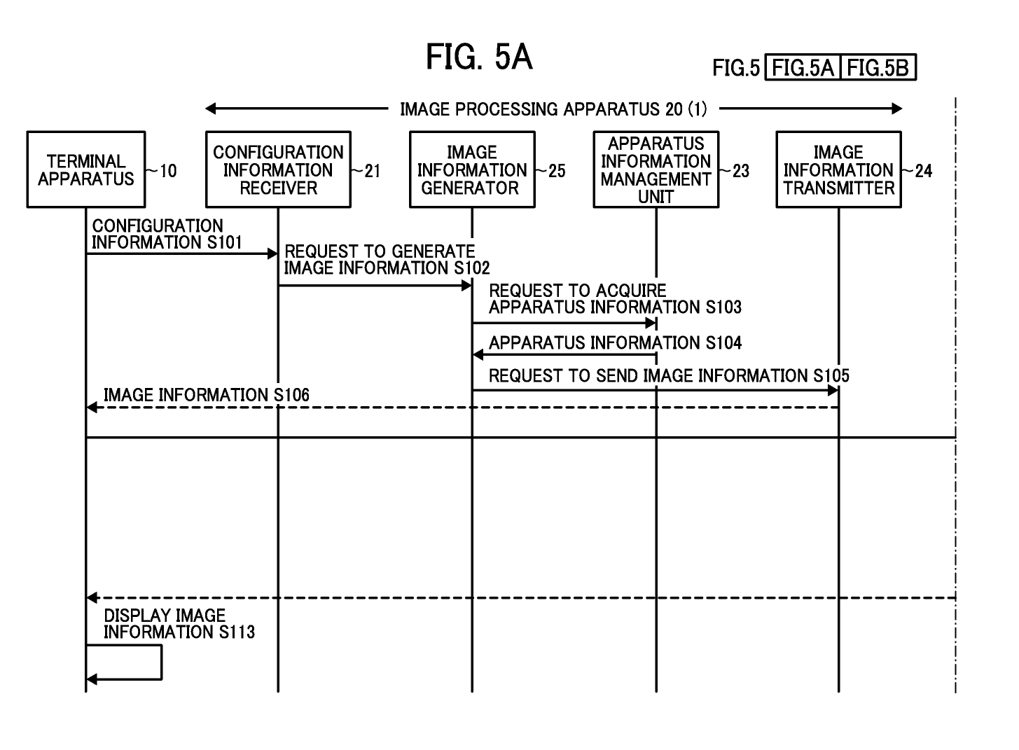

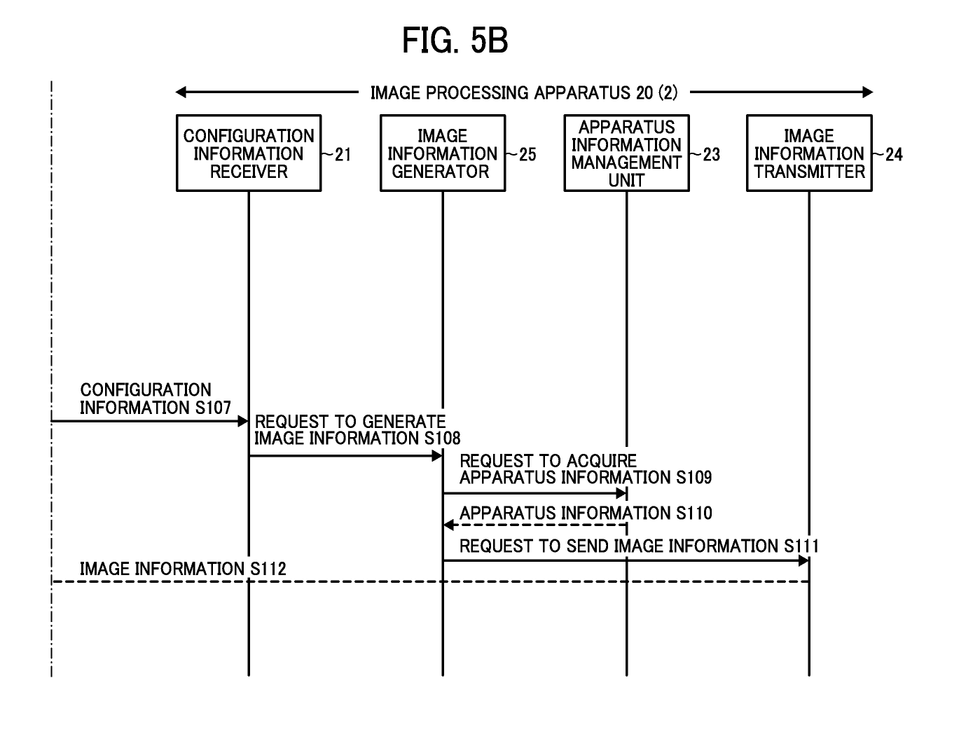

FIGS. 5A and 5B are sequence diagrams illustrating a process of sending and receiving image information between the terminal apparatus 10 and the multiple image processing apparatuses 20(1) and 20(2). First, the terminal apparatus 10 sends configuration information to the image processing apparatus 20(1) in S101. After receiving the configuration information, the configuration information receiver 21 in the image processing apparatus 20(1) sends a request to generate image information to the image information generator 25 in S102. After receiving the request to generate image information, the image information generator 25 sends a request to acquire apparatus information of the image processing apparatus 20(1) to the apparatus information management unit 23 in S103. After acquiring the apparatus information from the apparatus information management unit 23 in

S104, the image information generator 25 generates image information available by the image processing apparatus 20(1) based on the configuration information and the apparatus information and sends a request to send the image information to the image information transmitter 24 in S105. After receiving the request to send the image information, the image information transmitter 24 sends the image information to the terminal apparatus 10 in S106.

The terminal apparatus 10 sends the configuration information to the other image processing apparatus 20(2) either concurrently or sequentially in S107. After receiving the configuration information, the image processing apparatus 20(2) performs the same steps as in the image processing apparatus 20(1) described above, and the terminal apparatus 10 acquires the image information of the image processing apparatus 20(2) in steps from S108 to S112.

After acquiring image information from all of the image processing apparatuses 20(1) and 20(2) to which the terminal apparatus 10 sent the configuration information, the terminal apparatus 10 stores the acquired image information in the image information management unit 14. The image information display unit 15 displays an image based on the image information stored in the image information management unit 14 on a display screen of a display device (not shown in figures) in S113.

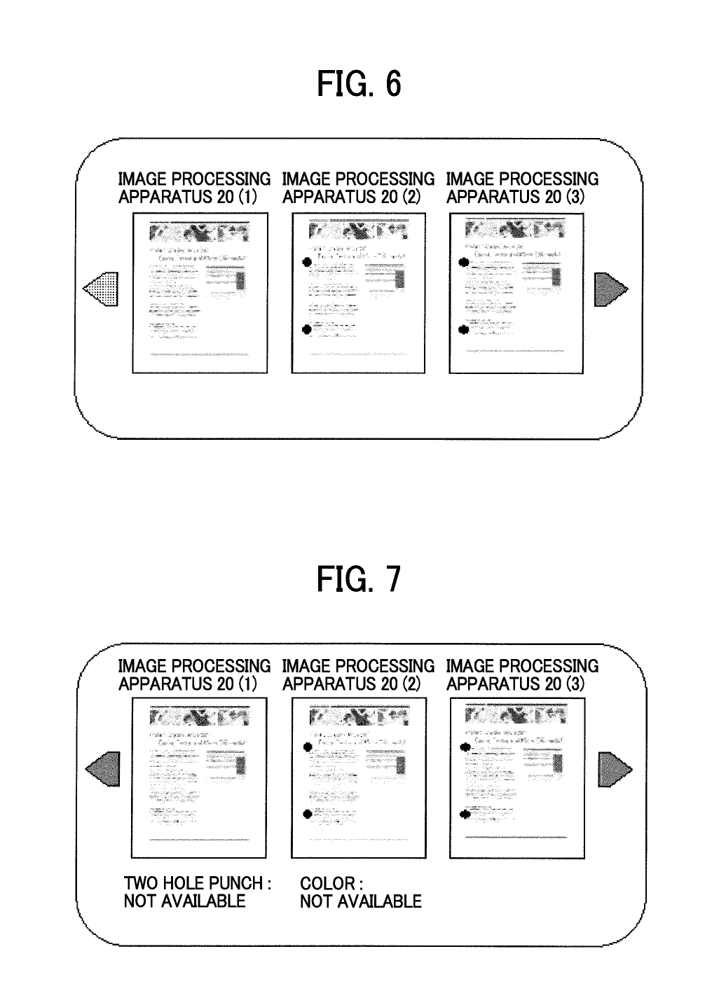

FIG. 6 is a diagram illustrating images displayed on the terminal apparatus 10 based on the image information. After browsing images for each of the image processing apparatuses 20(1), 20(2), and 20(3), the user determines which of the image processing apparatuses will be the output destination. As shown in FIG. 6, each of the image processing apparatus 20(1), 20(2), and 20(3) indicates an image outputtable by each of the image processing apparatus 20 in accordance with the configuration information set on the terminal apparatus 10. Here, if the user selects the image processing apparatus 20 as the output destination and specifies it on the terminal apparatus 10, the specified image processing apparatus 20 executes printing based on the configuration information of the terminal apparatus 10 that the image processing apparatus received and stored preliminarily.

As for the criteria used to select the output destination: FIG. 7 is a diagram illustrating images based on the image information and unsupported settings based on difference information between the configuration information and the image information displayed on the terminal apparatus 10. In this example, the process set by a user is determined to be unsupported, for example, when the process set by a user is inexecutable. If there is a difference between the image information sent from the image processing apparatus 20 and the configuration information set by the user, the image information display unit 15 displays both the image information and the difference of the configuration information on the display screen of the display device. Here, unsupported settings based on the difference information are indicated by “not available” so that the user can notice that easily. That is, as shown in FIG. 7, the image processing apparatus 20(1) cannot execute two hole punch, and the image processing apparatus 20(2) cannot execute color printing. On the other hand, the image processing apparatus 20(3) can execute all settings in the configuration information. Therefore, in this case, the image processing apparatus 20(3) is selected either by the user or automatically.

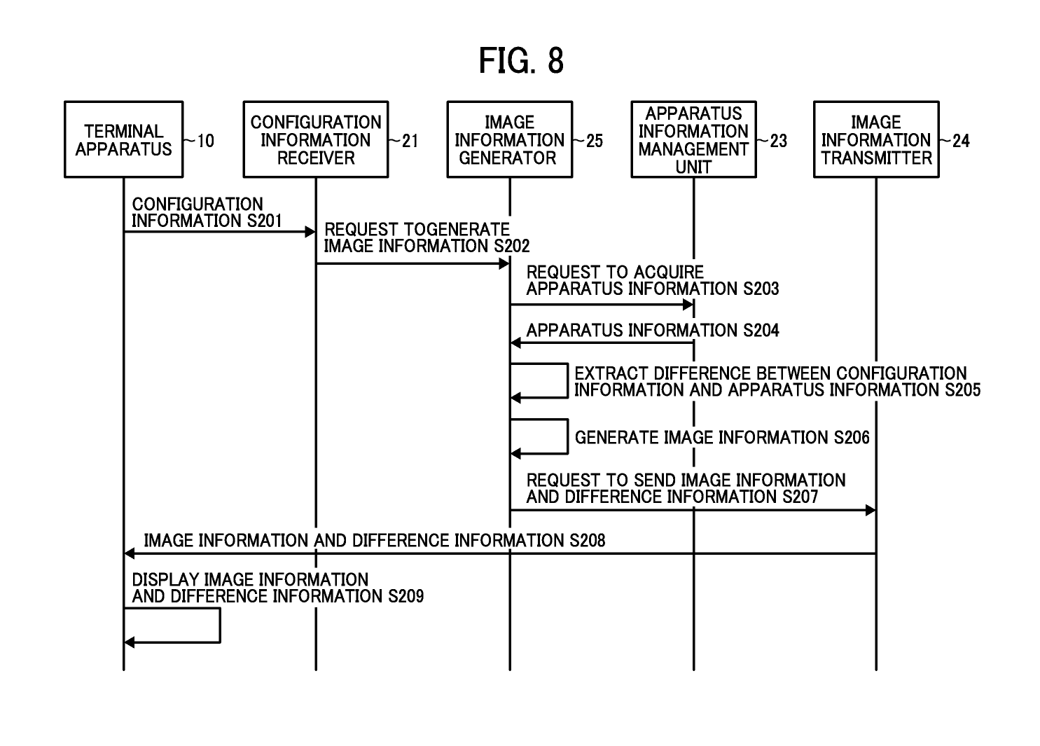

FIG. 8 is a sequence diagram illustrating the process shown in FIG. 7 to display unsupported settings based on the difference information between the image information and the configuration information on the terminal apparatus 10.

More specifically, the terminal apparatus 10 sends the configuration information to the image processing apparatus 20 in S201. After receiving the configuration information, the configuration information receiver 21 in the image processing apparatus 20 sends a request to generate image information to the image information generator 25 in S202. After receiving the request to generate the image information, the image information generator 25 sends a request to acquire apparatus information to the apparatus information management unit 23 in S203.

After acquiring the apparatus information from the apparatus information management unit 23 in S204, the image information generator 25 extracts the difference information between the configuration information and the apparatus information in S205 and generates image information based on settings in the configuration information that correspond with equivalents in the apparatus information in S206. Here, the system determines that capabilities included in the difference information are unsupported. Subsequently, the image information generator 25 sends a request to send the difference information in addition to the image information to the image information transmitter 24 in S207, and the image information transmitter 24 sends the image information and the difference information to the terminal apparatus 10 in S208. The image information display unit 15 displays images and unsupported settings such as “two hole punch: not available” based on the difference information on the display screen of the display device in S209.

Next, in case of executing post-processing, a process to display how the post-processing affects a printed image preliminarily will be described below.

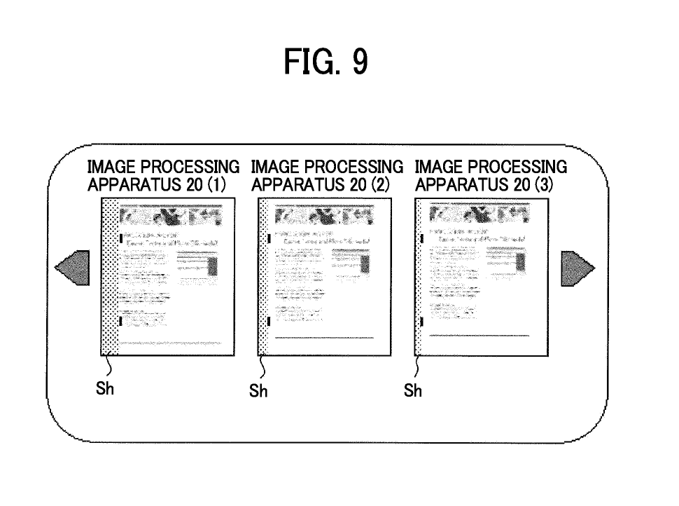

FIG. 9 is a diagram illustrating images based on the image information displayed on the terminal apparatus 10 and extent of effect of post-processing on printed images (overlapping of the image and the post-processing). In this case, after generating information on positions between outputting the image and the post-processing, the image information display unit 15 displays the image based on the image information on the display screen of the display device and document areas that can be hidden by the post-processing (shaded areas Sh shown in FIG. 9, the way of displaying is not limited thereto).

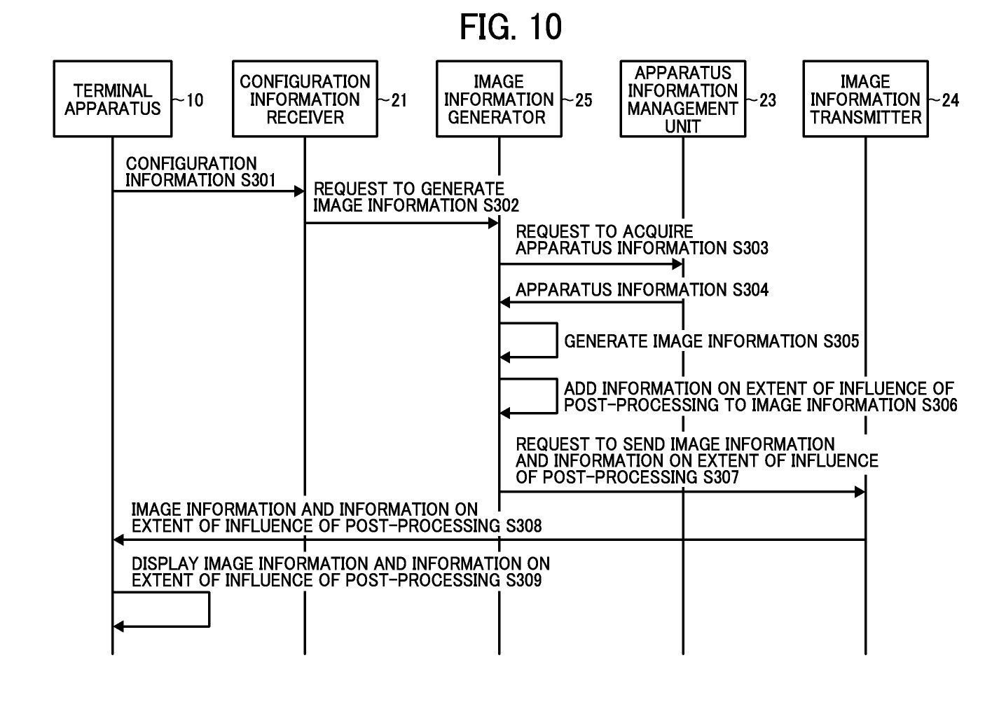

FIG. 10 is a sequence diagram illustrating the process shown in FIG. 9 to display image information and extent of effect of post-processing on the terminal apparatus 10. First, the terminal apparatus 10 sends the configuration information to the image processing apparatus 20 in S301. After receiving the configuration information, the configuration information receiver 21 in the image processing apparatus 20 sends a request to generate image information to the image information generator 25 in S302. After receiving the request to generate the image information, the image information generator 25 sends a request to acquire apparatus information to the apparatus information management unit 23 in S303. After acquiring the apparatus information from the apparatus information management unit 23 in S304, the image information generator 25 generates image information in S305. Concurrently, the image information generator 25 adds information on areas on the printed image affected by the post-processing (e.g., staple and punch), i.e., positional information that indicates areas Sh where the printed image is hidden to the image information in S306.

Next, the image information generator 25 sends a request to send image information and information on areas affected by the post-processing to the image information transmitter 24 in S307, and the image information transmitter 24 sends the image information and the information on areas affected by the post-processing to the terminal apparatus 10 in S308. After receiving the image information, the image information display unit 15 in the terminal apparatus 10 superimposes the area affected by the post-processing on the image information and displays it on the display screen of the display device in S309.

Next, a process to display remaining amount of supplies of the image processing apparatus 20 on the terminal apparatus 10 will be described below.

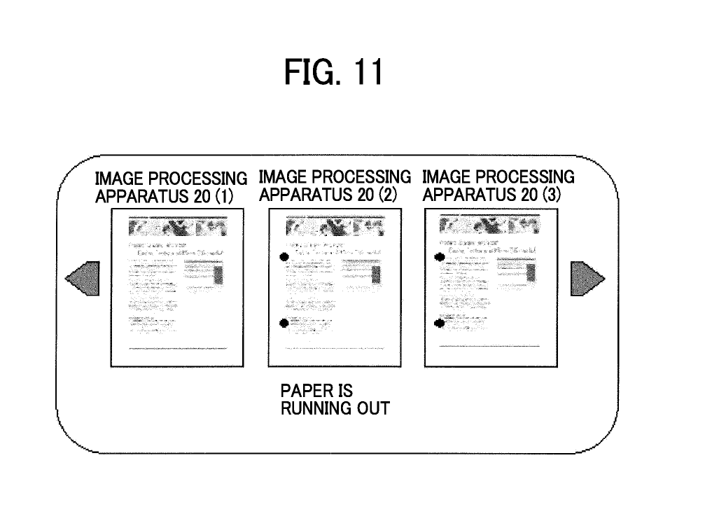

FIG. 11 is a diagram illustrating image information and remaining amount of supplies displayed on the terminal apparatus. In this case, the image processing apparatus 20(2) sends information that indicates that paper is running out to the terminal apparatus 10. After browsing the image information and the information on remaining amount of supplies displayed on the display screen of the terminal apparatus 10, the user can determine e.g., the image processing apparatus 20(3) as the output destination instead of the image processing apparatus 20(2).

While the message “paper is running out” is displayed in FIG. 11, in case of setting printing count on the terminal apparatus 10, it is possible to display that the image processing apparatus 20(2) as the output destination will lack the remaining amount of paper after printing the set printing count. Alternatively, it is possible to display the message when remaining amount of paper becomes less than a preset threshold value. Alternatively, if it is easier for the user to understand message “paper will run out”, the message can be displayed in that way. Furthermore, remaining amount of paper can be displayed either as an analog image or numerically. As described above, lack of remaining amount of supplies can be displayed arbitrarily in accordance with an adopted method to detect lack of supplies.

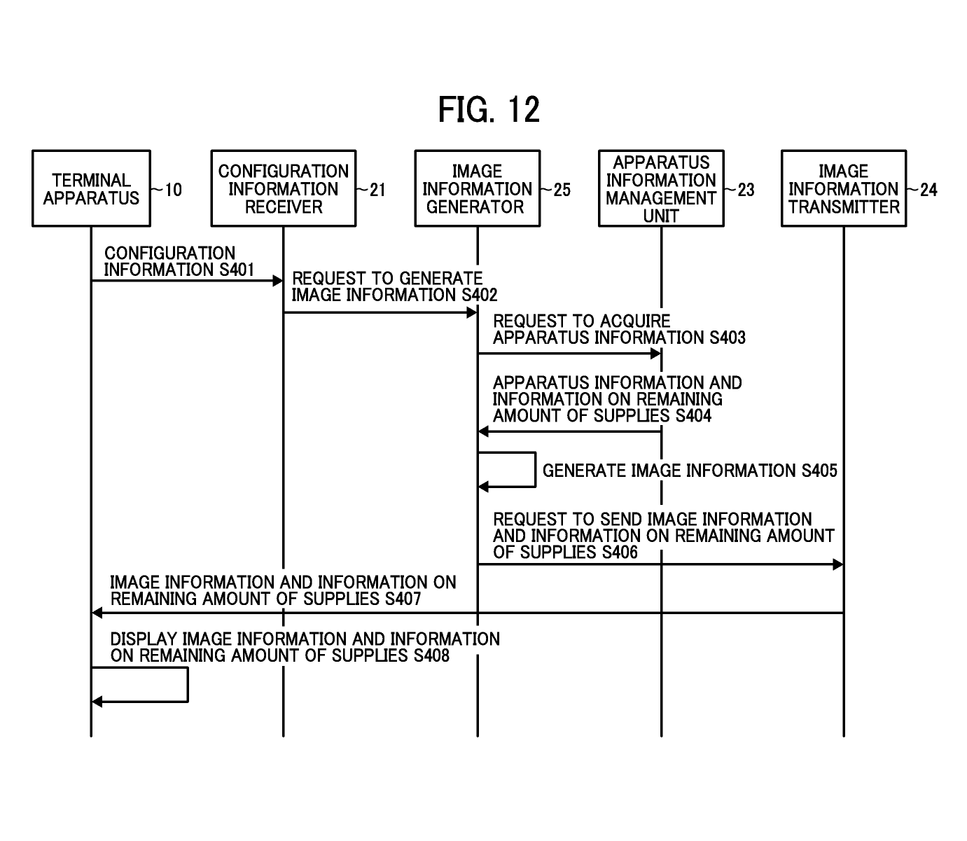

FIG. 12 is a sequence diagram illustrating the process shown in FIG. 11 to display image information and remaining amount of supplies on the terminal apparatus 10. After the terminal apparatus 10 sends the configuration information to the image processing apparatuses 20(1), 20(2), and 20(3) in S401, the configuration information receiver 21 in each of the image processing apparatuses 20(1), 20(2), and 20(3) sends a request to generate image information to the image information generator 25 in S402. After receiving the request to generate the image information, the image information generator 25 sends a request to acquire apparatus information to the apparatus information management unit 23 in S403. The image information generator 25 acquires the apparatus information and information on remaining amount of supplies from the apparatus information management unit 23 in S404 and generates the image information in S405. Subsequently, the image information generator 25 sends a request to send the image information and the information on remaining amount of supplies to the image information transmitter 24 in S406, and the image information transmitter 24 sends the image information and the information on remaining amount of supplies to the terminal apparatus 10 in S407. After receiving the image information and the information on remaining amount of supplies, the image information display unit 15 in the terminal apparatus 10 displays the image and the remaining amount of supplies on the display screen of the display device in S408.

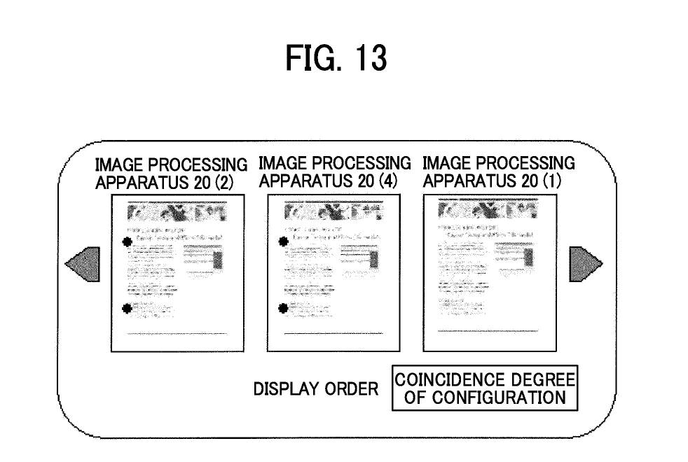

FIG. 13 is an ordinal diagram illustrating images based on image information sent from the multiple image processing apparatuses 20 displayed on the terminal apparatus 10. In this case, images are displayed laying out in order of descending number of setting information items executable in accordance with the configuration information set by the user based on the image information sent from the multiple image processing apparatuses 20. In FIG. 13, images are laid out in the order of the image processing apparatus 20(2), the image processing apparatus 20(4), and the image processing apparatus 20(1).

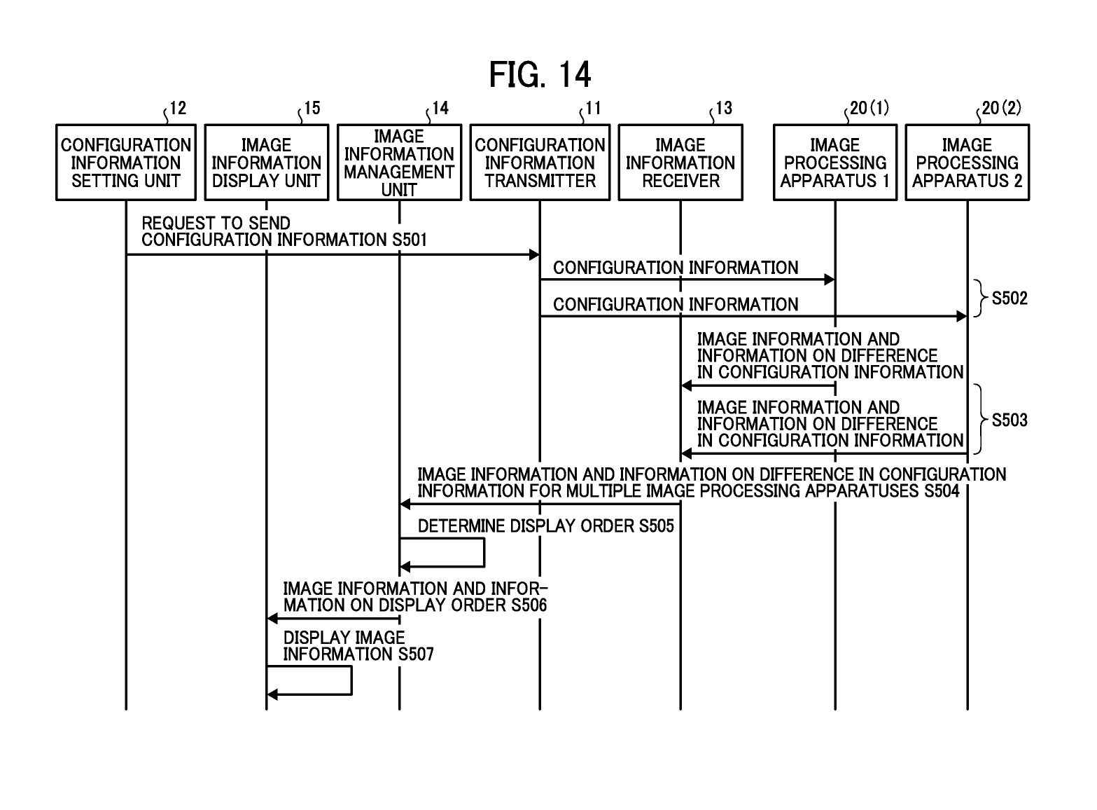

FIG. 14 is a sequence diagram illustrating the process shown in FIG. 13 to determine displaying order of image information on the terminal apparatus 10. First, the configuration information setting unit 12 in the terminal apparatus 10 sends a request to send configuration information to the configuration information transmitter 11 in S501. After receiving the request to send the configuration information, the configuration information transmitter 11 sends the configuration information to the image processing apparatuses 20(1) and 20(2) in S502. After receiving the configuration information, the image processing apparatuses 20(1) and 20(2) send difference information between the configuration information and the image information along with its own image information to the image information receiver 13 in the terminal apparatus 10 in S503.

The image information receiver 13 sends the received difference information between the image information and the print configuration of the multiple image processing apparatuses 20(1) and 20(2) to the image information management unit 14 in S504. The image information management unit 14 determines displaying order of the image information to lay out in order of descending number of items executable in accordance with the configuration information set by the user based on the image information and the difference information in S505 and sends them to the image information display unit 15 in S506. The image information display unit 15 displays the images in order of being laid out as described above on the display screen of the display device in S507.

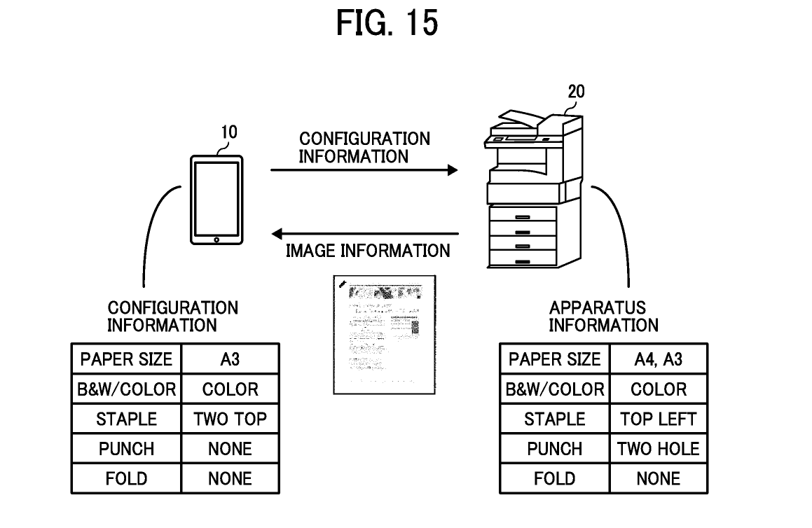

FIG. 15 is a diagram illustrating a displaying process based on the image information in case process set by the user is unsupported and process nearest to the print configuration set by the user is executed. In this embodiment, in preparation for a case that post-processing requested by the user is unsupported on the image processing apparatus, it is possible to select either “not to execute post-processing requested by the user” or “to execute post-processing nearest to post-processing requested by the user” on each of the image processing apparatuses 20 in response to a command from the terminal apparatus 10 for example.

Here, “post-processing nearest to post-processing requested by the user” means a process substitutable for the post-processing in the configuration request even though conditions differ to a certain degree in case the post-processing specified in the configuration request is unsupported on each of the image processing apparatuses. In FIG. 15, while the configuration request includes “staple: two top”, a substitute process executable on the image processing apparatus 20 is “staple: top left”. Consequently, the image information generator generates image information that includes “staple: top left”, which is displayed on the terminal apparatus 10.

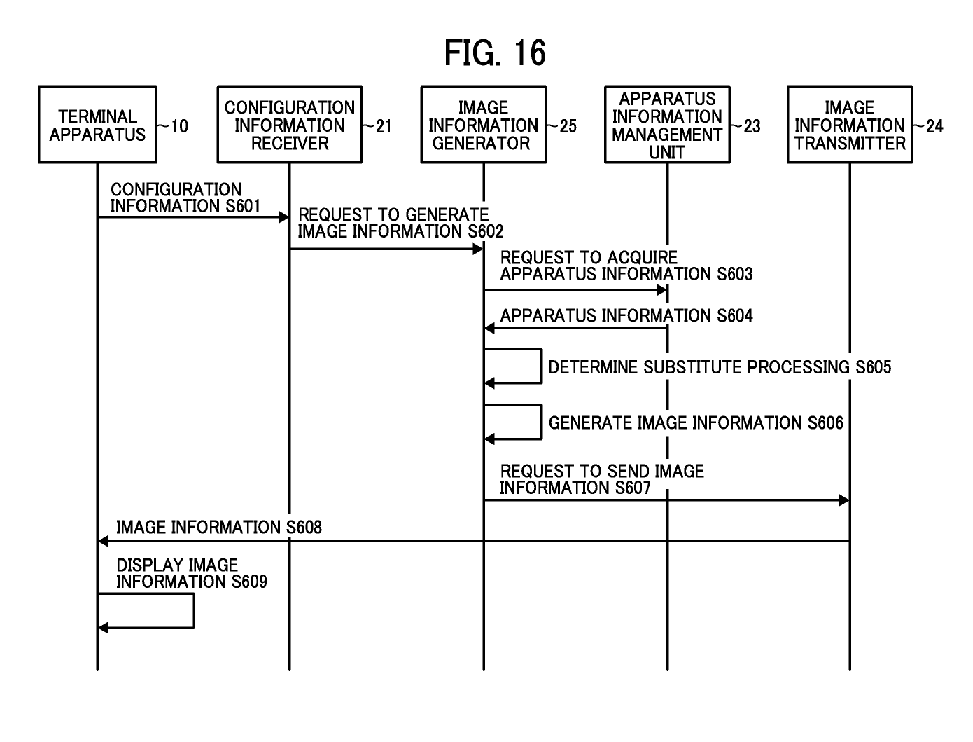

FIG. 16 is a sequence diagram illustrating the process shown in FIG. 15 to request configuration and send and receive image information that includes a substitute process between the terminal apparatus 10 and the image processing apparatus 20 in case it is selected “to execute post-processing nearest to post-processing requested by the user”. First, the terminal apparatus 10 sends configuration information to the image processing apparatus 20 in S601. After receiving the configuration information, the configuration information receiver 21 in the image processing apparatus 20 sends a request to generate image information to the image information generator 25 in S602. The image information generator 25 sends a request to acquire apparatus information to the apparatus information management unit 23 in S603 and acquires the apparatus information from the apparatus information management unit 23 in S604.

Here, the image information generator 25 determines whether the image processing apparatus 20 can execute a substitute process or not in S605. If it is possible to execute the substitute process, the image information generator 25 generates image information that includes the substitute process in S606 and sends a request to send the image information to the image information transmitter 24 in S607. After receiving the request to send the image information, the image information transmitter 24 sends the image information to the terminal apparatus 10 in S608. Subsequently, the image information display unit 15 in the terminal apparatus 10 displays an image on the display screen of the display device based on the image information in S609.

By performing the process described above between the terminal apparatus 10 and the image processing apparatus 20, the user can select the image processing apparatus 20 with reference to the displayed images of the substitute process.

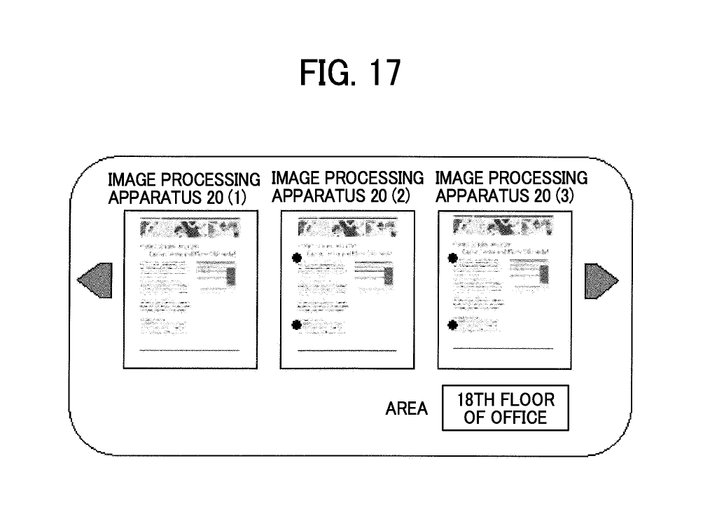

FIG. 17 is a diagram illustrating displayed images and area information in case of specifying (or limiting) installation location of the image processing apparatus 20. The user can limit the image processing apparatus 20 that the user requests to generate image information by specifying an area where output apparatuses are located (e.g., 18th floor of office in FIG. 17).

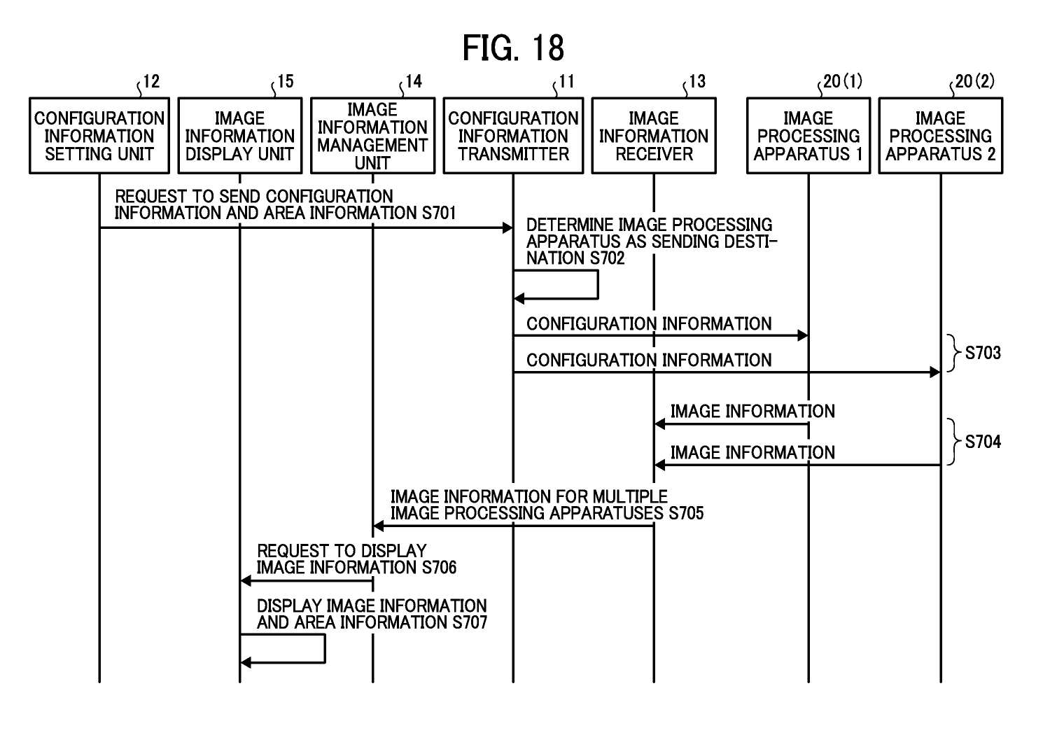

FIG. 18 is a sequence diagram illustrating the process shown in FIG. 17 to specify the installation location of the image processing apparatus 20. First, after the user specifies area of the image processing apparatus 20, the configuration information setting unit 12 in the terminal apparatus 10 sends a request to send configuration information and area information to the configuration information transmitter 11 in S701. After receiving the request to send the configuration information and the area information, the configuration information transmitter 11 determines the image processing apparatus as sending destination in the area in S702 and sends the configuration information to the image processing apparatuses 20(1) and 20(2) in S703. After receiving the configuration information, the image processing apparatuses 20(1) and 20(2) send its own image information in S704. After receiving the image information from the image processing apparatuses 20(1) and 20(2), the image information receiver 13 sends the image information received from the image processing apparatuses 20(1) and 20(2) to the image information management unit 14 in S705. After receiving the image information, the image information management unit 14 sends the image information to the image information display unit 15 in S706. Subsequently, the image information display unit 15 displays images on the display screen of the display device based on the image information received from the image processing apparatuses 20(1) and 20(2) and area based on the area information in S707. By selecting the image processing apparatus 20 within the displayed area, the user can limit the desired area such as the area where the user is in and the neighbor areas and can perform printing by using the image processing apparatus 20 in the area.

As described above, in the embodiment of the present invention, the user can select the most appropriate image processing apparatus 20 to acquire desired print output flexibly and easily depending on the situation.

The present invention may reside in a method, performed by a terminal apparatus, comprising the steps of configuring input configuration information, sending the configuration information configured in the input configuration information configuring step to an image processing apparatus, receiving image information outputtable by the image processing apparatus in accordance with the transmitted configuration information, and displaying an image generated based on the image information received in the image information receiving step.

The present invention may reside in a method, performed by an image processing apparatus, comprising the steps of receiving configuration information sent from a terminal apparatus, managing apparatus information that indicates output and post-processing executable by the image processing apparatus, generating image information outputtable by the image processing apparatus based on the received configuration information and the apparatus information, sending the image information generated by the image information generator to the terminal apparatus, and outputting an image based on the received configuration information in response to a command to output sent from the terminal apparatus.

The present invention may reside in a program stored on a recording medium that executes the above-described method.

Numerous additional modifications and variations are possible in light of the above teachings. It is therefore to be understood that, within the scope of the appended claims, the disclosure of this patent specification may be practiced Alternatively than as specifically described herein.

As can be appreciated by those skilled in the computer arts, this invention may be implemented as convenient using a conventional general-purpose digital computer programmed according to the teachings of the present specification. Appropriate software coding can readily be prepared by skilled programmers based on the teachings of the present disclosure, as will be apparent to those skilled in the software arts. The present invention may also be implemented by the preparation of application-specific integrated circuits or by interconnecting an appropriate network of conventional component circuits, as will be readily apparent to those skilled in the relevant art.

What is claimed is:

1. A terminal apparatus configured to connect with a plurality of image processing apparatuses via a network, comprising:
a configuration information setting unit to configure input configuration information;
a configuration information transmitter to send the configuration information configured by the configuration information setting unit to the image processing apparatus;
an image information receiver to receive image information outputtable by the image processing apparatus in accordance with the transmitted configuration information; and
an image information display unit to display an image generated based on the image information received by the image information receiver,
wherein the displayed image allowing a user to select one of the plurality of image processing apparatuses.

2. The terminal apparatus according to claim 1, further comprising an image information management unit to manage the image information received by the image information receiver,
wherein the image information management unit sorts the image processing apparatuses by degree of difference between the configuration information and apparatus information of the image processing apparatuses, and the image information display unit displays the image processing apparatuses in order of similarity.

3. The terminal apparatus according to claim 1, further comprising a specifying unit to specify an installation area of the image processing apparatus,
wherein the configuration information transmitter sends the configuration information to the image processing apparatus located in the specified area.

4. An image processing apparatus connected with a terminal apparatus via a network, comprising:
a configuration information receiver to receive configuration information sent from the terminal apparatus;
an apparatus information management unit to manage apparatus information that indicates output and post-processing executable by the image processing apparatus;
an image information generator to generate image information outputtable by the image processing apparatus based on the received configuration information and the apparatus information;
an image information transmitter to send the image information generated by the image information generator to the terminal apparatus; and
an image output unit to output an image based on the received configuration information in response to a command to output sent from the terminal apparatus.

5. The image processing apparatus according to claim 4, wherein the image information generator generates difference information between the configuration information and the apparatus information sent from the apparatus information management unit.

6. The image processing apparatus according to claim 4, wherein the image information generator generates position information that indicates image output position and post-processing position, and the image information transmitter adds the position information that indicates the image output position and the post-processing position to the image information and sends the image information to the terminal apparatus.

7. The image processing apparatus according to claim 4, wherein the image information generator acquires information on remaining amount of supplies in the image processing apparatus from the apparatus information management unit, and the image information transmitter sends the image information and the information on remaining amount of supplies to the terminal apparatus.

8. An information processing system, comprising:
a terminal apparatus, including:
a configuration information setting unit to configure input configuration information;
a configuration information transmitter to send the configuration information configured by the configuration information setting unit to the image processing apparatus;
an image information receiver to receive image information outputtable by the image processing apparatus in accordance with the transmitted configuration information; and
an image information display unit to display an image generated based on the image information received by the image information receiver, and
an image processing apparatus connected to the terminal apparatus via a network, including:
a configuration information receiver to receive configuration information sent from the terminal apparatus;
an apparatus information management unit to manage apparatus information that includes output and post-processing executable by the image processing apparatus;
an image information generator to generate image information outputtable by the image processing apparatus based on the received configuration information and the apparatus information;
an image information transmitter to send the image information generated by the image information generator to the terminal apparatus; and
an image output unit to output an image based on the received configuration information in response to a command to output sent from the terminal apparatus, wherein the image processing apparatus that executes an output process is selectable among a plurality of the image processing apparatuses based on the displayed image.
